(19) United States
(12) Patent Application Publication
(10) Pub. No.: US 2011/0283616 A1
(43) Pub. Date: Nov. 24, 2011

(54) APPARATUS AND METHOD FOR CULTIVATING STRAWBERRIES AND SMALL LEAFY VEGETABLES USING MULTILAYERED DEVICE

(76) Inventor: Hyuk Kang, Gyeongsangnam- Do (KR)

(21) Appl. No.: 13/147,364

(22) PCT Filed: Mar. 23, 2009
(86) PCT No.: PCT/KR2009/001465

§ 371 Date: Aug. 1, 2011

(30) Foreign Application Priority Data
Jan. 30, 2009 (KR) 10-2009-0007230

(51) Int. Cl. A01G 9/02

(52) U.S. Cl. 47/66.7; 47/79

(57) ABSTRACT

The present invention relates to an apparatus and a method for cultivating strawberries and small leafy vegetables using a multi-layered device. The apparatus comprises a support plate in which a plurality of holes, which are paths for water and/or a nutrition solution, are formed in order to enable massive harvesting and cultivation of bulbous crops and decorative plants as well as strawberries and small leafy vegetables. A main body comprising a plurality of constant-sized holes for planting and cultivating strawberries and small leafy vegetables at a constant interval is located in the upper part of the support plate. The main body is filled with soil mixed with one or two or more selected from peat moss, coarse sand, charcoal, chaff mixture, carbonized chaff, perlite, organic mixture bed soil, and yellow soil in order to supply the crops planted in the side of the main body with water and nutrition solutions through the roots thereof. A pipe or a hose in installed in the center of the main body to supply the injected water and nutrition solutions to the crops through the bed soil in the main body in order to cultivate the crops well. The multi-layered device is designed and manufactured to transplant seedlings planted in a port nursery to the holes formed in the main body.

### TECHNICAL FIELD

The present invention relates to an apparatus and a method for cultivating bulbous crops and decorative plants as well as strawberries and small leafy vegetables in bulk in a small place. More Particularly, the present invention relates to an apparatus and a method for cultivating strawberries and small leafy vegetables using a multi-layered device in which a pipe or a hose is installed to supply water and/or nutrition solutions to the crops through bed soil in a main body, which is filled with the soil mixed with one or two or more selected from peat moss, coarse sand, charcoal, chaff mixture, carbonized chaff, perlite, organic mixture bed soil and yellow soil in order to supply the crops planted in the side of the main boy with water and/or nutrition solutions through the roots thereof.

### BACKGROUND ART

In general, cultivation of bulbous crops and decorative plants as well as strawberries and small leafy vegetables in vinyl houses is conducted in a level cultivation, and thus increase in production per unit area is difficult due to limitation of the facility area where such cultivation is conducted. As a result, intensive cultivation or input of a plenty of chemical fertilizers has been used to increase the production quantity.

Also, in the case of strawberries and small leafy vegetables which require great manpower for cultivation or harvesting, plenty of manpower should be ensured. However, as workers should bend their bodies while working and face extreme working environment, and as a result, they tend to avoid such work, and ensuring required manpower is not easy.

Typically, crops which are cultivated in vinyl houses may catch various diseases (graymoldrot) in the high temperature and humidity, closed environment. In such case, bacteria spread rapidly through the soil or space, and one cannot obtain good cultivation results even if plenty of agricultural chemicals are sprayed. Then, the remaining component of the agricultural chemicals of strawberries and small leafy vegetables may approach a risky level, and harm consumers taking such strawberries or vegetables, and farmers may be poisoned by the agricultural chemicals at the time of spraying the chemicals.

As another related art, Registered Utility Model Publication No. 20-0352715 discloses a method for extending the cultivation area by using the surface of a cylinder by converting the cultivation area from the horizontal concept to the vertical concept with respect to cultivation of vine-ripe fruit. However, as an additional pipe is not installed to efficiently supply water and nutrition solutions, the crops are not efficiently cultivated. Also, as fruit is placed on the fruit support plate, it is contaminated by soil, dust and bacteria in the support plate. Since sowing holes are lower than the height of the vegetable support plate, sowing seeds is not easy. Further, the cultivation container is filled with soil and composts and is thus heavy. As seeds are sowed in the sowing holes instead of using young plant grown in ports, it is hard to forecast the possibility of survival.

### DISCLOSURE

### Technical Problem

The present invention has been made to solve the problems and it is an object of the present invention to provide an apparatus and a method for cultivating bulbous crops and decorative plants as well as strawberries and small leafy vegetables using a multi-layer device, which increases the production quantity several times to fifteen times or more than in a level cultivation, installs a waterspout in a lower part thereof for growing strawberries or vegetables at home or for educational purpose, and enables cultivation, decoration or exhibition of flowers or particular plants in multi-layers in parks, lobbies in buildings, roadsides, event halls, etc.

Another aspect of the present invention is to provide an apparatus and a method for cultivating strawberries and small leafy vegetables using a multi-layered device which allows workers to cultivate crops at a height of approximately 180 cm with a multi-layered device in a comfort working environment, protects the back of workers and improves the working environment.

Another aspect of the present invention is to provide an apparatus and a method for cultivating strawberries and small leafy vegetables using a multi-layered device which prevents the widespread of diseases in strawberries and small leafy vegetables by easily removing the layer of such strawberries and vegetables catching diseases and spraying agricultural chemicals, minimizes the quantity of sprayed agricultural chemicals and keeps workers and consumers safe from the agricultural chemicals.

Another aspect of the present invention is to provide an apparatus and a method for cultivating strawberries and small leafy vegetables using a multi-layered device which enables harvesting of strawberries and vegetables in a clean state as fruits or leaves do not touch the passage or ground, and coats or attaches a reflecting material such as aluminum to an external surface of a main body to secure ultraviolet rays and visible rays to thereby encourage equal growth of crops by the ultraviolet rays reflected by the main body and enable fruits become ripe for high quality.

Another aspect of the present invention is to provide an apparatus and a method for cultivating strawberries and small leafy vegetables using a multi-layered device which installs a rotation unit in a bottom of the multi-layered device and allows workers to perform necessary duties and conduct harvesting in a single place for a prompt performance, and supplies crops with ultraviolet rays and visible rays uniformly for growth.

### Technical Solution

In order to achieve the object of the present invention, an apparatus and a method for cultivating strawberries, ginseng, small leafy vegetables, bulbous crops and decorative plants using a multi-layered device comprises a support plate in which a plurality of holes, which are paths for water and/or a nutrition solution, are formed in order to enable massive harvesting and cultivation of bulbous crops and decorative plants as well as strawberries, ginseng and small leafy vegetables. A main body comprising a plurality of constant-sized holes for planting and cultivating strawberries and small leafy vegetables at a constant interval is located in the upper part of the support plate. The main body is filled with soil mixed with one or two or more selected from peat moss, coarse sand, charcoal, chaff mixture, carbonized chaff, perlite, organic mixture bed soil, and yellow soil in order to supply the crops planted in the side of the main body with water and nutrition solutions through the roots thereof. A pipe or a hose in installed in the center of the main body to supply the injected water and nutrition solutions to the crops through the bed soil in the main body in order to cultivate the crops well. The multi-layered device is designed and manufactured to transplant seedlings planted in a port nursery to the holes formed in the main body.

In order to achieve the object of the present invention, an apparatus for cultivating strawberries and small leafy vegetables using a multi-layered device has a main body and a support plate separated from each other to spray agricultural chemicals by removing layers in which strawberries and small leafy vegetables catch various diseases (graymoldrot), and forms at least two projections as handle and ground fixer to replace or remove the main body from the support plate.

In order to achieve the object of the present invention, an apparatus for cultivating strawberries and small leafy vegetables using a multi-layered device has a main body, whose external surface is coated with a reflection material including aluminum or is attached with a reflection film to secure as much as violet rays and visible rays to encourage uniform growth of crops and fruits by the ultraviolet rays and visible rays reflected by the main body.

In order to achieve the object of the present invention, an apparatus for cultivating strawberries and small leafy vegetables in bulk has a reference groove formed in a side of a main body and support plate and acting as a basis for assembly and enables an easy assembly in multi layers.

In order to achieve the object of the present invention, an apparatus for cultivating strawberries and small leafy vegetables in bulk enables workers to perform their duties and conduct harvesting in a single place for a prompt performance and has a rotation unit installed in a bottom of the multi-layered device to uniformly supply violet rays and visible rays to crops.

In order to achieve the object of the present invention, a method for cultivating strawberries and small leafy vegetables using a multi-layered device comprises designing and manufacturing an apparatus for cultivating bulbous crops and decorative plants as well as strawberries and small leafy vegetables using a multi-layered device; planting bulbous crops and decorative plants as well as strawberries and small leafy vegetables in ports shaped like a cone with a maximum diameter of approximately 3 cm; transplanting the bulbous crops and decorative plants as well as strawberries and small leafy vegetables from the ports to a plurality of holes formed in the main body of the apparatus at constant intervals and height; and supplying water and/or nutrition solutions to the strawberries, small leafy vegetables, bulbous crops and decorative plants.

In order to achieve the object of the present invention, an apparatus for cultivating strawberries and vegetables has a waterspout in a bottom thereof to grow strawberries and vegetables at home or for educational purposes, and is used to grow or decorate flowers or particular plants in parks, lobbies of buildings, roadsides, events halls and places.

### Advantageous Effect

As described above, an apparatus and a method for cultivating bulbous crops and decorative plants as well as strawberries and small leafy vegetables using a multi-layer device according to the present invention increases the production quantity several times to fifteen times or more than in a level cultivation, installs a waterspout in a lower part thereof for growing strawberries or vegetables at home or for educational purpose, and enables cultivation, decoration or exhibition of flowers or particular plants in multi-layers in parks, lobbies in buildings, roadsides, event halls, etc.

Also, an apparatus and a method for cultivating strawberries and small leafy vegetables using a multi-layered device according to the present invention allows workers to cultivate crops at a height of approximately 100 cm to 180 cm with a multi-layered device in a comfort working environment, protects the back of workers and improves the working environment as the apparatus uses a multi-layered device including three to six layers.

Further, an apparatus and a method for cultivating strawberries and small leafy vegetables using a multi-layered device according to the present invention prevents the widespread of diseases in strawberries and small leafy vegetables by easily removing the layer of such strawberries and vegetables catching diseases and spraying agricultural chemicals, minimizes the quantity of sprayed agricultural chemicals and keeps workers and consumers safe from the agricultural chemicals.

Further, an apparatus and a method for cultivating strawberries and small leafy vegetables using a multi-layered device according to the present invention enables harvesting of strawberries and vegetables in a clean state as fruits or leaves do not touch the passage or ground, and coats or attaches a reflecting material such as aluminum to an external surface of a main body to secure ultraviolet rays and visible rays to thereby encourage equal growth of crops by the ultraviolet rays reflected by the main body and enable fruits become ripe for high quality.

Further, an apparatus and a method for cultivating strawberries and small leafy vegetables using a multi-layered device according to the present invention has a rotation unit installed in a bottom of the multi-layered device and allows workers to perform necessary duties and conduct harvesting in a single place for a prompt performance, and supplies crops with ultraviolet rays and visible rays uniformly for growth.

### BRIEF DESCRIPTION OF DRAWINGS

FIG. 1 is a plan view and a front view of a main body of an apparatus for cultivating strawberries and small leafy vegetables using a multi-layered device according to the present invention.

FIG. 2 is a plan view of a support plate of the multi-layered device according to the present invention.

FIG. 3 illustrates a type of a pipe which supplies water and nutrition solutions to crops.

FIG. 4 is an exploded perspective view of a multi-layered (two-layered) device for cultivating strawberries and small leafy vegetables in bulk according to the present invention.

FIGS. 5 to 7 illustrate various shapes of the multi-layered device for massive cultivation.

FIG. 8 illustrates an example of a configuration of a rotation unit rotating the multi-layered device.

FIG. 9 illustrates another example of a configuration of a rotation unit rotating the multi-layered device.

### BRIEF DESCRIPTION OF NUMERALS IN DRAWINGS

11: Main body 12: holes for planting crops 13: upper surface reference groove (main body)
14: support plate 15: pipe hole 16: holes formed in projections
17: projections as handle and ground fixer 18: holes which are paths for water and nutrition solutions
19: reference groove (support plate) 20: bolt to fix the ground
21: pipe for supplying water and/or nutrition solutions 22: holes for supplying water and/or nutrition solutions
23: lower surface reference groove (main body) 24: closure film 25: projection
31: upper rotation plate 32: lower fixing plate 33: ball bearing
34: reference groove 35: ball bearing insertion groove (lower fixing plate)
36: ball bearing rotation guiding groove (upper rotation plate)

### BEST MODE

Hereinafter, an apparatus and a method for cultivating strawberries and small leafy vegetables using a multi-layered device according to exemplary embodiments of the present invention will be described in detail with reference to accompanying drawings. As shown in FIG. 1, a pipe 21 having minutes holes 22 formed therein is installed in a central portion of a main body 11 to supply water and/or nutrition solutions to crops through soil provided in the main body 11 by providing water and/or nutrition solutions to grow crops, or a hose or a pipe is installed in and penetrates a hole 15 formed in a central portion of a support plate 14 to supply water and/or nutrition solutions per layer. The main body 11 is fined with soil mixed with one or two or more selected from peat moss, coarse sand, charcoal, chaff mixture, carbonized chaff, perlite, organic mixture bed soil, and yellow soil in order to supply the crops planted in the plurality holes of the main body 11 with water and nutrition solutions through the roots thereof.

Each of the plurality of holes 12 formed in the main body 11 is 3 cm in diameter. After bulbous crops and decorative plants as well as strawberries and small leafy vegetables are grown into port seedlings with a diameter of approximately 3 cm, the seedlings are transplanted to the holes 12 formed in the main body 11 with the port removed therefrom for growth. The thickness of the main body 11 is 0.5 cm to 1 cm. The main body 11 is designed and manufactured in a cylindrical shape in 40 cm×50 cm size. At the side of the main body 11, the holes 12 are formed at a constant interval to plant approximately 24 crops upward and downward.

### First Exemplary Embodiment

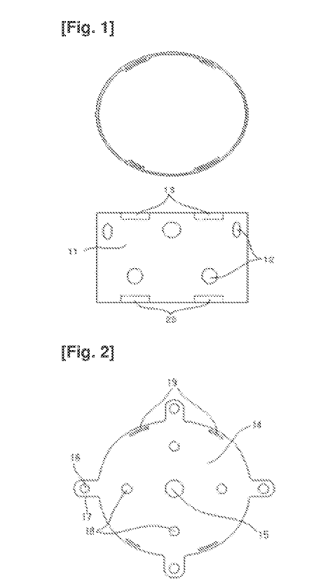

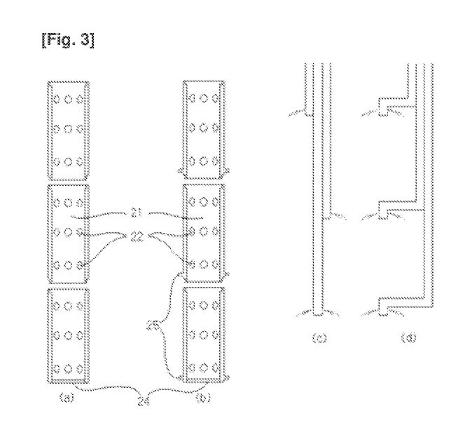

FIG. 1 illustrates a main body 11 of an apparatus for cultivating strawberries and small leafy vegetables using a multi-layered device. Reference grooves 13 and 23 are formed in upper and lower surfaces of the main body 11 for workers to easily assemble the multi-layered device. A reference groove 19 is also formed in a support plate 14 in FIG. 2 in line with the reference grooves 12 and 23 of the upper and lower surfaces of the main body 11. The reference grooves 13, 23 and 19 formed in the main body 11 and the support plate 14 may be coupled with a wire or a large nail to make the inter-layers firm.

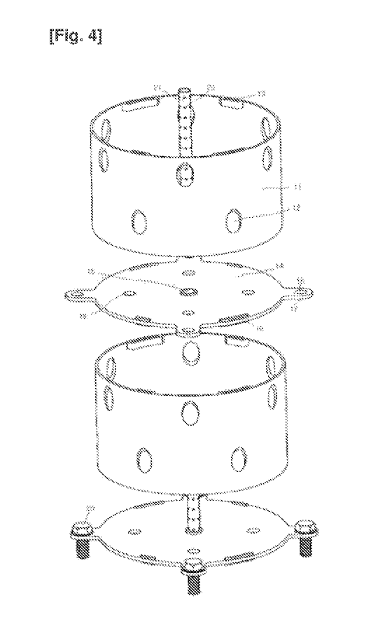

FIG. 4 is a perspective view of a double-layered apparatus for cultivating strawberries and small leafy vegetables using a multi-layered device. More specifically, a lower support plate 14 of the apparatus using the multi-layered device in FIG. 4 is firmly fixed to the ground by a bolt 20. The main body 11 is located in an upper surface of the support plate 14 in line with the reference grooves formed in the support plate 14. A pipe 21 having minute holes 22 may be installed in a central portion of the support plate 14 to supply water and/or nutrition solutions, or a plurality of thin pipes or hoses may be provided in the central part as in (b) in FIG. 3 to spray or inject water and/or nutrition solutions for each layer.

The numerals representing the shape of the main body 11 is an exemplary embodiment specifically explaining the shape and size which is available at the time of cultivating crops. The size of the main body 11, the size of the holes 12 formed in the main body 11 and the intervals between the holes 12 may be smaller or larger than the foregoing numerals in consideration of the purpose and the type of crops.

The material of the main body 11 in FIG. 1 may include one of plastic, synthetic resin, styrofoam, FRP, stainless steel, aluminum, glass, ceramic and compressed pulp. The diameter and height of the cylindrical main body 11 may vary depending on each crop.

FIGS. 1 to 4 illustrate the main body 11 which has a cylindrical shape, but the shape of the main body 11 is not limited thereto. Alternatively, the main body 11 may have various shapes including a conical, elliptical or regular polygonal shape, based on FIGS. 1 to 4.

An external surface of the main body 11 is coated with a reflection material including aluminum or is attached with a reflection film to reflect ultraviolet rays and visible rays generated from sunlight or light emitting diode (LED) to secure as much as ultraviolet rays and visible rays by reflection. The main body 11 is configured to receive rays and ensures uniform growth of crops and fruits with ultraviolet rays and visible rays reflected by the reflection material attached to or coating the main body 11.

The support plate 14 in FIG. 2 supports bed soil in various types filling the main body 11. Three to eight holes 18 are formed in 1 cm diameter in the support plate 14 by which supplied water and/or nutrition solutions fall downward by gravity.

At four edges of the support plate 14, projections 17 as a handle and ground fixer are formed. A fixing groove 16 is formed in the projections 17 as handle and ground fixer to be fixed to the ground firmly by nail or bolt when the support plate 14 is provided in a bottom. A support plate 14 which is provided on top in a multi-layer assembly is manufactured to act as a handle so that workers may take out or replace the main body 11 due to disease (graymoldrot) or damage to the main body 11.

FIG. 3 illustrates a pipe 21 for supplying nutrition solutions and water. The pipe 21 is designed and manufactured to penetrate the center of the main body 11 and the support plate 14. Minute holes 22 are formed in a surface of the pipe 21. A closure film 24 (refer to FIG. 3) is formed in the bottom of the pipe 21 to allow water and/or nutrition solutions to be naturally sprayed and permeate through the bed soil in the main body 11 in multi-layers through the minute holes 22 formed in the side of the pipe 21 by pressure instead of being discharged to a lower portion of the pipe 21.

The pipe 21 supplying water and/or nutrition solutions may be designed and manufactured to be round or have at least two projections 25 (refer to FIG. 3) by being held to the hole formed in the center of the support plate 14 not to go down further as in (b) in FIG. 3. The pipe 21 supplying water and/or nutrition solutions has a closed end, and may be designed and manufactured in various configurations including a configuration designed and manufactured to be assembled and installed by layer in consideration of the height of the main body 11 and support plate 14, a configuration designed and manufactured to be assembled and coupled by two layers and a configuration designed and manufactured to use multi-layers as one layer.

Another configuration for supplying water and/or nutrition solutions may be manufactured to spray or inject water and/or nutrition solutions to a top layer so that the supplied water and/or nutrition solutions move to lower layers through holes by gravity to supply them gradually.

Another configuration for supplying water and/or nutrition solutions may be manufactured to have a thin hose or pipe installed in an outside, form a hole on an upper portion of the main body 11 to insert the thin hose or pipe thereinto, insert into or install the hose or pipe to the formed hole and spray or inject water and/or nutrition solutions per layer as in (d) in FIG. 3. Another configuration for supplying water and/or nutrition solutions may be manufactured to install a plurality of pipes or hoses in an upper central portion of the main body 11 and spray or inject water and/or nutrition solutions per layer through the installed hoses or pipes as in (c) in FIG. 3.

A storage tank and a pipe are installed in an upper portion of the pipe 21 having the minute holes formed therein to supply water and/or nutrition solutions. An electronic control valve or manual control valve is installed in a side of the pipe 21 to control the supply of water and/or nutrition solutions, i.e., to automatically supply water and/or nutrition solutions at predetermined intervals or to control the supply manually. The storage tank which is used to supply water and/or nutrition solutions is installed in a high location to make water and/or nutrition solutions fall downward, or an additional injection pump may be installed in a side of the pipe 21.

In the case of the storage tank supplying water and nutrition solutions, a tank supplying water and nutrition solutions to crops through a single pipe by mixing the water and nutrition solutions or supplying water or nutrition solutions, a pipe and a control valve are installed additionally. Control valves are installed additionally in the two pipes. The two pipes may be manufactured to be incorporated into one pipe from the lower portion where the control valves are provided so as to supply water and nutrition solutions separately or concurrently to crops.

FIG. 4 illustrates the main body 11 and the support plate 14 which are coupled consecutively in multi-layers. In consideration of the height of vinyl houses in various shapes such as a semi-circle or eave, and work efficiency of workers, the main body 11 and the support plate 14 may be assembled in various layers selected from two, three, four, five, six and seven layers. The main body 11 and the support plate 14 are designed and manufactured to maximize productivity per unit area in consideration of an efficient utilization of the inside of the vinyl houses and work efficiency of workers.

Different types of crops or plants may be planted in the single main body or the multi-layer device.

### Second Exemplary Embodiment

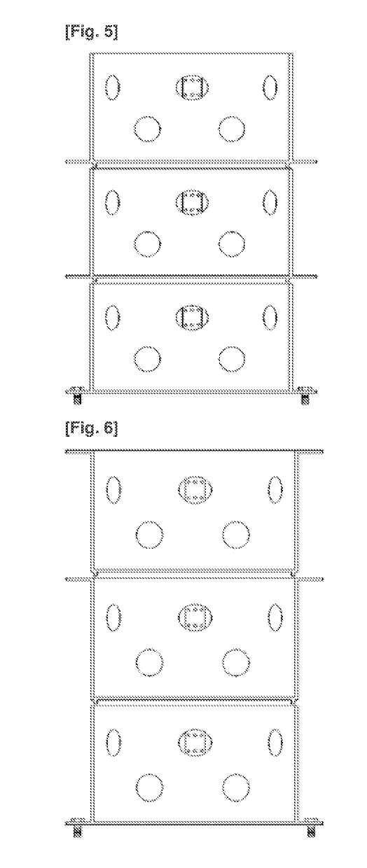

As shown in FIGS. 5 to 7, according to the second exemplary embodiment, a multi-layer device for cultivating bulbous crops and decorative plants as well as strawberries and small leafy vegetables is designed and manufactured in various shapes.

FIGS. 5 and/or 6 illustrates the support plate and the main body formed in a single body. FIG. 5 illustrates the projection as handle and bottom fixer formed in the bottom of the main body. FIG. 6 illustrates the handle formed integrally on an upper part of the main body.

As shown in FIGS. 5 and 6, in the multi-layered device having the support plate and main body formed as a single body, one of the multi-layer devices is provided in a flat ground, and a pipe or hose which has minute holes in a surface thereof is installed in the center to spray or inject water and/or nutrition solutions to efficiently cultivate crops. The pipe has a closed end so that water and/or nutrition solutions is naturally sprayed or permeates through the bed soil through the minute holes by gravity.

Like in the first exemplary embodiment, the multi-layered device according to the second exemplary embodiment may supply water and/or nutrition solutions with the configuration as in (c) and (d) in FIG. 3 or by spraying water and/or nutrition solutions from the top.

FIGS. 5 and 6 illustrate the main body and the support plate which are manufactured as a single body and assembled in multi-layers (three layers). In consideration of the height of vinyl houses in various shapes and work efficiency of workers, the multi-layered device may be designed and manufactured to improve productivity per unit area by assembling the layers in various layers selected from two, three, four, five, six and seven layers.

An external surface of the multi-layered device for cultivating bulbous crops and decorative plants as well as strawberries and small leafy vegetables with the main body and the support plate formed as a single body is coated with a reflection material including aluminum or is attached with a reflection film to reflect ultraviolet rays to grow crops and fruit. The foregoing configuration is the same as that according to the first exemplary embodiment.

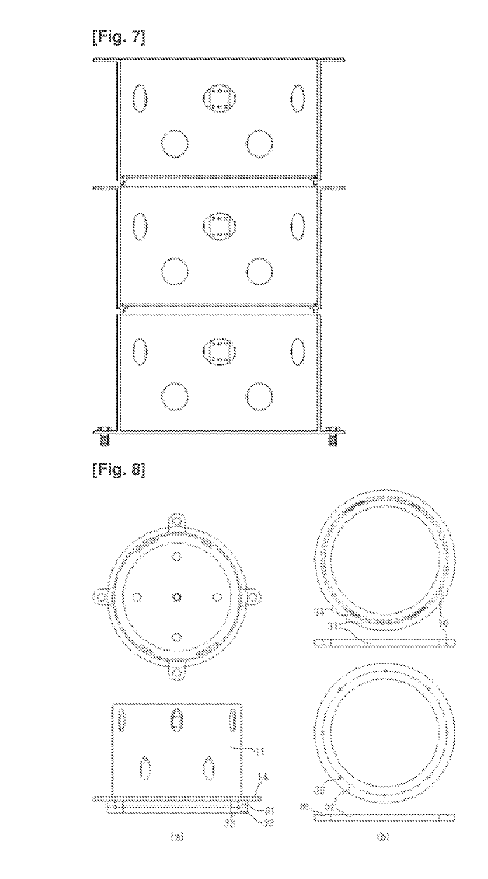

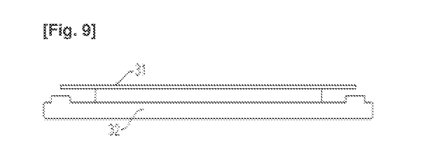

FIG. 7 illustrates a multi-layered device according to another exemplary embodiment of the present invention which is designed and manufactured to insert an additional support plate in an inside by forming a projection in a bottom in the configuration in FIG. 6.

As long as any apparatus for cultivating strawberries, small leafy vegetables, bulbous crops and decorative plants uses a vertical multi-layered device in various shapes instead of performing a level cultivation, has holes therein to transplant crops from ports thereto, and has a pipe having minute holes formed therein installed in an side or center of the device to supply water and/or nutrition solutions and enables cultivation by several times to fifteen times or more in production quantity per unit area than in level cultivation, it is merely modified in design from the apparatus for cultivating crops using the multi-layered device according to the present invention and belongs to the protective scope of the present invention.

### Third Exemplary Embodiment

According to the third exemplary embodiment of the present invention, a method for cultivating bulbous crops and decorative plants as well as strawberries and small leafy vegetable using a multi-layered device designed and manufactured based on the first and second exemplary embodiments is provided.

Like in the first and second exemplary embodiments, according to the third exemplary embodiment, a multi-layered device for cultivating bulbous crops and decorative plants as well as strawberries and small leafy vegetables is designed and manufactured. Bulbous crops and decorative plants as well as strawberries and small leafy vegetables are planted in a port shaped like a funnel with a maximum diameter of 3 cm.

The bulbous crops and decorative plants as well as strawberries and small leafy vegetables which have been grown in the port are removed from the port and transplanted to the plurality holes formed in the apparatus to plant the bulbous crops and decorative vegetables as well as strawberries and small leafy vegetables in predetermined intervals and height.

Then, the crops planted in the holes formed in the main body take roots in the bed soil mixed with one or two or more selected from peat moss, coarse sand, charcoal, chaff mixture, carbonized chaff, perlite, organic mixture bed soil and yellow soil and receive water and/or nutrition solutions to grow.

The method for cultivating bulbous crops and decorative plants as well as strawberries and small leafy vegetables according to the third exemplary embodiment is used to cultivate crops or plants by using the cultivating apparatus designed and manufactured variously according to the first and second exemplary embodiments.

As shown in FIG. 8, if a rotation unit is additionally installed in the bottom of the multi-layered device designed and manufactured according to the first to third exemplary embodiments, workers may work or harvest at a single location and rotate certain angles periodically to uniformly grow plants and fruits with ultraviolet rays and visible rays. The rotation unit is designed and manufactured by inserting a ball bearing 33 between an upper rotation plate 31 and a lower fixing plate 32 as in FIG. 8.

A ball bearing guiding groove 36 is formed in the bottom of the upper rotation plate 31 in a triangular or other various shapes at a predetermined distance from the center so that the ball bearing 33 may rotate without separation. A reference groove 34 is formed on the top of the upper rotation plate 31 in the same location as the reference groove 19 formed in the support plate 13 so that workers may assemble the device without difficulty.

A ball bearing insertion groove 35 is formed on the top of the lower fixing plate 32 at the same distance from the center so that the plurality of ball bearings 33 may rotate in a single place without separation.

The upper rotation plate 31 and the lower fixing plate 32 are designed and manufactured to be hollow inside or as a flat panel. The material of the upper rotation plate 31 and the lower fixing plate 32 may include a metal material which is stainless and firm, or a synthetic resin such as plastic.

In another rotation method, the upper rotation plate 31 may be designed and manufactured to rotate by injecting a lubricant oil or grease to reduce the friction force to the portion where the upper rotation plate 31 and the lower fixing plate 32 contact each other.

If the rotation unit is installed and rotates in the bottom, various configurations which do not leak water and is rotatable may be coupled to the top of the line supplying water and/or nutrition solutions to accommodate rotation of the multi-layered device (e.g., a tap of a sink installed to be rotatable).

A rotation motor is installed in the rotation unit so that the rotation unit rotates horizontally or in a single direction periodically, and thus rotates automatically at predetermined time intervals to thereby facilitate uniform growth of plants or rotates at a certain angle manually by manipulating switches.

In the apparatus and method for cultivating strawberries and small leafy vegetables using the multi-layered device according to the first to third exemplary embodiments of the present invention, a waterspout may be installed in the bottom of the apparatus to cultivate or produce strawberries or vegetables at home or for educational purposes. The apparatus may be used to grow and decorate flowers or particular plants in multi-layers in parks, lobbies of buildings, roadsides, various event halls and places or displaying such flowers or plants for decoration of exhibitions.

The apparatus and method for cultivating strawberries and small leafy vegetables according to the present invention is applicable to crops and plants which may be transplanted to holes in a main body of the apparatus after seedlings grown from ports are removed from such ports.

### INDUSTRIAL APPLICABILITY

An apparatus and method for cultivating strawberries and small leafy vegetables using a multi-layered device according to the present invention enables massive harvesting and cultivation of bulbous crops and decorative plants as well as strawberries and small leafy vegetables to thereby greatly improve productivity per unit area, enable cultivation in a clean state and reduce use of agricultural chemicals.

Although a few exemplary embodiments have been shown and described, it will be appreciated by those skilled in the art that changes may be made in these exemplary embodiments without departing from the principles and spirit of the invention, the range of which is defined in the appended claims and their equivalents.

1. An apparatus for cultivating strawberries, small leafy vegetables, bulbous crops and decorative plants, the apparatus comprising:
a support plate in which a plurality of holes, which allows water and/or nutrition solutions to fall downward by gravity when the water and/or nutrition solutions are supplied, is formed;
a main body which is provided on a top of the support plate, has a plurality of holes formed in a side thereof to sow and cultivate strawberries and small leafy vegetables, and is filled with soil mixed with one or two or more selected from peat moss, coarse sand, charcoal, chaff mixture, carbonized chaff, perlite, organic mixture bed soil, and yellow soil to supply the crops planted in the side of the main body with water and/or nutrition solutions;
a pipe or a hose which is installed in a central portion of the main body, and supplies the injected water and nutrition solutions to the crops through the bed soil in the main body in order to cultivate the crops well; and
a multi-layered device which is assembled and manufactured in at least two layers with the support plate, main body and pipe.

2. An apparatus for cultivating strawberries, small leafy vegetables, bulbous crops and decorative plants, the apparatus comprising:
a main body which has a plurality of holes, which allows water and/or nutrition solutions to fall downward by gravity when the water and/or nutrition solutions are supplied, formed in a bottom surface, has a plurality of holes formed in a side thereof to plant and cultivate crops, and is filled with soil mixed with one or two or more selected from peat moss, coarse sand, charcoal, chaff mixture, carbonized chaff, perlite, organic mixture bed soil, and yellow soil to supply the crops planted in the side of the main body with water and/or nutrition solutions;
a pipe or a hose which is installed in a central portion of the main body, and supplies the injected water and nutrition solutions to the crops through the bed soil in the main body in order to cultivate the crops well; and
a multi-layered device which is assembled and manufactured in at least two layers with the support plate, main body and pipe.

3. An apparatus for cultivating strawberries, small leafy vegetables, bulbous crops and decorative plants, the apparatus comprising:
a support plate in which a plurality of holes which allows water and/or nutrition solutions to fall downward by gravity when the water and/or nutrition solutions are supplied, is formed;
a main body which is provided on a top of the support plate, has a plurality of holes formed in a side thereof to plant and cultivate strawberries and small leafy vegetables, and is filled with soil mixed with one or two or more selected from peat moss, coarse sand, charcoal, chaff mixture, carbonized chaff, perlite, organic mixture bed soil, and yellow soil to supply the crops planted in the side of the main body with water and/or nutrition solutions;
a pipe or a hose for which an insertion groove is formed in an upper side of the main body to insert the pipe or hose thereinto, which is installed through the insertion groove from the external side of the main body and sprays or injects water and/or nutrition solutions to the crops through the bed soil within the main body for growth of the crops; and
a multi-layered device which is assembled and manufactured in at least two layers with the support plate, main body and pipe.

4. The apparatus according to claim 1, wherein in the support plate having the plurality of holes formed therein, at least two projections as handle and ground fixer are provided to be used as a handle when an assembly and separation operation is performed, and is used to fix the apparatus firmly to the ground if it is provided in the bottom.

5. The apparatus according to claim 1, further comprising a reference groove which is formed in the support plate and upper and lower surfaces of the main body to enable an easy assembly when the support plate and the main body are assembled and to couple the support plate and the main body firmly by wire or long nail.

6. The apparatus according to claim 1, wherein an external surface of the main body is attached with a reflection film or coated with a reflection material including aluminum to reflect ultraviolet rays and visible rays to uniformly grow crops and fruits.

7. The apparatus according to claim 2, wherein more than two handles are installed on a top or bottom of the main body to enable workers to assemble or disassemble the support plate and the main body without difficulty.

8. The apparatus according to claim 1, wherein a storage tank is installed in an upper part of the pipe or hose to store and supply water and nutrition solutions therein, and a pipe or a hose is additionally installed between the storage tank and pipe or hose to supply water and/or nutrition solutions, and a control valve is further installed in a side of the pipe to control the supply of water and/or nutrition solutions.

9. The apparatus according to claim 1, wherein a closure film is installed in the bottom of the pipe or hose supplying water and/or nutrition solutions not to leak such water and/or nutrition solutions downward, and a pipe for supplying water and/or nutrition solutions is formed as a female-male coupling configuration to be assembled by layer or is formed in at least two layers.

10. The apparatus according to claim 1, further comprising an upper rotation plate which has a guiding groove formed in a bottom of the apparatus to guide a ball bearing to rotate the multi-layered device;
a lower fixing plate which has a ball bearing insertion groove formed therein to enable the ball bearing to rotate in a single place without separation; and
a coupling means which enables the ball bearing to be inserted into the insertion groove formed in the upper fixing plate and accommodates a rotation of the apparatus from the top of the pipe supplying water and/or nutrition solutions.

11. The apparatus according to claim 1, further comprising a waterspout which is formed in a bottom of the apparatus to be easily installed for educational purposes, or in parks, lobbies of buildings, roadsides, various event halls and places.

12. A method for cultivating strawberries, small leafy vegetables, bulbous crops and decorative plants, the method comprising:
designing and manufacturing an apparatus for cultivating strawberries, small leafy vegetables, bulbous crops and decorative plants with a multi-layered device having a plurality of holes formed in a side thereof by installing a pipe or a hose supplying water and/or nutrition solutions;
planting and growing strawberries, small leafy vegetables, bulbous crops and decorative plants in ports shaped like a cone;
removing the strawberries, small leafy vegetables, bulbous crops and decorative plants from the ports and transplanting the strawberries, small leafy vegetables, bulbous crops and decorative plants to holes formed in the apparatus designed and manufactured as above; and
supplying water and/or nutrition solutions to the strawberries, small leafy vegetables, bulbous crops and decorative plants to take roots in the soil filling the main body and comprising one or two or more selected from peat moss, coarse sand, charcoal, chaff mixture, carbonized chaff, perlite, organic mixture bed soil and yellow soil.

13. The method according to claim 12, wherein the designing and manufacturing comprises attaching a reflection film to, or coating, an external surface of the side of the apparatus with a reflection material to reflect ultraviolet rays and visible rays to uniformly grow crops and fruits.

14. The method according to claim 12, wherein the designing and manufacturing further comprises adding a rotation unit in a bottom of the apparatus to rotate the apparatus.

15. The apparatus according to claim 3, wherein in the support plate having the plurality of holes formed therein, at least two projections as handle and ground fixer are provided to be used as a handle when an assembly and separation operation is performed, and is used to fix the apparatus firmly to the ground if it is provided in the bottom.

16. The apparatus according to claim 3, further comprising a reference groove which is formed in the support plate and upper and lower surfaces of the main body to enable an easy assembly when the support plate and the main body are assembled and to couple the support plate and the main body firmly by wire or long nail.

17. The apparatus according to claim 2, wherein an external surface of the main body is attached with a reflection film or coated with a reflection material including aluminum to reflect ultraviolet rays and visible rays to uniformly grow crops and fruits.

18. The apparatus according to claim 3, wherein an external surface of the main body is attached with a reflection film or coated with a reflection material including aluminum to reflect ultraviolet rays and visible rays to uniformly grow crops and fruits.

19. The apparatus according to claim 2, wherein a storage tank is installed in an upper part of the pipe or hose to store and supply water and nutrition solutions therein, and a pipe or a hose is additionally installed between the storage tank and pipe or hose to supply water and/or nutrition solutions, and a control valve is further installed in a side of the pipe to control the supply of water and/or nutrition solutions.

20. The apparatus according to claim 3, wherein a storage tank is installed in an upper part of the pipe or hose to store and supply water and nutrition solutions therein, and a pipe or a hose is additionally installed between the storage tank and pipe or hose to supply water and/or nutrition solutions, and a control valve is further installed in a side of the pipe to control the supply of water and/or nutrition solutions.

21. The apparatus according to claim 2, further comprising an upper rotation plate which has a guiding groove formed in a bottom of the apparatus to guide a ball bearing to rotate the multi-layered device;

22. The apparatus according to claim 3, further comprising an upper rotation plate which has a guiding groove formed in a bottom of the apparatus to guide a ball bearing to rotate the multi-layered device;

23. The apparatus according to claim 3, further comprising a waterspout which is formed in a bottom of the apparatus to be easily installed for educational purposes, or in parks, lobbies of buildings, roadsides, various event halls and places.
